(19) United States
(12) Patent Application Publication
(10) Pub. No.: US 2010/0284332 A1
(43) Pub. Date: Nov. 11, 2010

(54) METHOD FOR TRANSMITTING AND RECEIVING DATA IN MULTI CARRIER WIRELESS ACCESS SYSTEM

(75) Inventors: Eunkyung KIM, Seoul (KR); Jae Sun Cha, Daejeon (KR); Juhee Kim, Daejeon (KR); Soojung Jung, Daejeon (KR); Kwang Jae Lim, Daejeon (KR); Hyun Lee, Daejeon (KR); Chul Sik Yoon, Seoul (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Deajeon (KR)

(21) Appl. No.: 12/769,204

(22) Filed: Apr. 28, 2010

(30) Foreign Application Priority Data
Apr. 28, 2009 (KR) 10-2009-0036912
Apr. 28, 2010 (KR) 10-2010-0039352

(51) Int. Cl. H04W 4/00

(52) U.S. Cl. 370/328

(57) ABSTRACT

There is provided a method in which a base station transmits downlink data in a wireless access system supporting multi-carriers. The method comprising negotiating with a terminal about a sleep mode parameter including information on a sleep window and a listening window, if the terminal is operating in a sleep mode, transmitting information on a carrier used for data transmission among the multi-carriers to the terminal through at least one of a medium access control (MAC) header, a MAC control message, and a control channel and transmitting data to the terminal based on the information during the listening window. Accordingly, waste of radio resources can be prevented by making efficient use of the multi-carriers even though the terminal is operating in the sleep mode.

### CROSS-REFERENCE TO RELATED APPLICATION

This application claims priority to and the benefit of Korean Patent Application Nos. 10-2009-0036912 and 10-2010-0039352 filed in the Korean Intellectual Property Office on Apr. 28, 2009 and Apr. 28, 2010, the entire contents of which are incorporated herein by reference.

### BACKGROUND OF THE INVENTION

(a) Field of the Invention

The present invention relates to a wireless access system. More particularly, the present invention relates to a method for transmitting and receiving data in a wireless access system supporting multi-carriers.

(b) Description of the Related Art

At present, research on wireless access systems supporting multi-carriers (MC) is actively under way. A multi-carrier environment allows for more efficient communication compared to a single-carrier environment. For instance, a terminal can use a wider bandwidth, and a base station can serve more users.

In a general multi-carrier environment, two types of carriers, i.e., a primary carrier and a secondary carrier, are defined. The primary carrier means a carrier for transmitting and receiving data and a control message between a terminal and a base station. The primary carrier can be used for general operations of the terminal, such as network access. The secondary carrier means an additional carrier that can be used for data transmission and reception in response to the control message transmitted through the primary carrier. The terminal is controlled through the primary carrier, which is one of multi-carriers, and can use at least one secondary carrier for data transmission and reception.

Meanwhile, the terminal can operate in a sleep mode to save power. The terminal can receive an aperiodic data service and/or a periodic data service during the sleep mode. The aperiodic data service is, for example, a best effort (BE) traffic service or a non-real-time variable rate (NRT-VR) traffic service. The periodic data service is, for example, an unsolicited grant service (UGS) or a real-time variable rate (RT-VR) traffic service.

If the terminal operating in the sleep mode receives the aperiodic data service, the base station transmits a traffic advertisement message to the terminal during a listening window (or listening interval). The terminal, having received the traffic advertisement message, receives data as in a normal mode. On the contrary, the terminal operating in the sleep mode receives the periodic data service, and can periodically receive data during a listening window irrespective of reception of the traffic advertisement message.

In a wireless access system supporting multi-carriers, if a terminal operates in a sleep mode, the terminal receives data during a listening window by using a plurality of carriers. This causes a waste of radio resources.

### SUMMARY OF THE INVENTION

The present invention has been made in an effort to provide a method for transmitting and receiving data in a wireless access system supporting multi-carriers. Particularly, the present invention provides a method for transmitting and receiving data when a terminal operates in a sleep mode.

One exemplary embodiment of the present invention provides a method in which a base station transmits downlink data in a wireless access system supporting multi-carriers, the method comprising: negotiating with a terminal about a sleep mode parameter including information on a sleep window and a listening window; if the terminal is operating in a sleep mode, transmitting information on a carrier used for data transmission among the multi-carriers to the terminal through at least one of a medium access control (MAC) header, a MAC control message, and a control channel; and transmitting data to the terminal based on the information during the listening window.

One exemplary embodiment of the present invention provides a method in which a terminal operates in a sleep mode in a wireless access system supporting multi-carriers, the method comprising: negotiating with a base station about a sleep mode parameter including information on a sleep window and a listening window; if the terminal is operating in the sleep mode, receiving information on a carrier used for data transmission among the multi-carriers from the base station through at least one of a medium access control (MAC) header, a MAC control message, and a control channel; and receiving data from the base station based on the information during the listening window.

One exemplary embodiment of the present invention provides a sleep mode controlling apparatus of a base station of a wireless access system supporting multi-carriers, the apparatus comprising: a parameter setting unit for negotiating with a terminal about a sleep mode parameter including information on a sleep window and a listening window; and a transmission unit for, if the terminal is operating in a sleep mode, transmitting information on a carrier used for data transmission among the multi-carriers to the terminal through at least one of a medium access control (MAC) header and a MAC control message, and transmitting data to the terminal based on the information during the listening window.

Data can be efficiently transmitted and received in a wireless access system supporting multi-carriers. Particularly, a waste of radio resources can be prevented by making efficient use of the multi-carriers even though a terminal is operating in a sleep mode.

### BRIEF DESCRIPTION OF THE DRAWINGS

FIG. 1 is a schematic block diagram of a sleep mode controlling apparatus according to one exemplary embodiment of the present invention.

FIG. 2 is a flowchart showing a method for transmitting data from a base station to a terminal according to one exemplary embodiment of the present invention.

FIG. 3 is a flowchart showing a method for transmitting data from a base station to a terminal according to another exemplary embodiment of the present invention.

FIG. 4 is a flowchart showing a. method in which a base station provides a periodic data transmission service to the terminal while the terminal is operating in a sleep mode in a wireless access system supporting multi-carriers according to one exemplary embodiment of the present invention.

FIG. 5 is a flowchart showing a method in which a base station provides a periodic data transmission service to a terminal while the terminal is operating in a sleep mode in a wireless access system supporting multi-carriers according to another exemplary embodiment of the present invention.

FIG. 6 is a flowchart showing a method in which a base station provides a periodic data transmission service and an aperiodic data transmission service to a terminal while the terminal is operating in a sleep mode in a wireless access system supporting multi-carriers according to one exemplary embodiment of the present invention.

FIG. 7 is a flowchart showing a method in which a base station provides a data transmission service to a terminal while the terminal is operating in a sleep mode in a wireless access system supporting multi-carriers according to one exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In this specification, a mobile station (MS) may designate a terminal, a mobile terminal (MT), a subscriber station (SS), a portable subscriber station (PSS), user equipment (UE), an access terminal (AT), and so on. Moreover, the mobile station may include all or a part of functions of the terminal, the mobile terminal, the subscriber station, the portable subscriber station, the user equipment, the access terminal and so on.

In this specification, a base station (BS) may designate an access point (AP), a radio access station (RAS), a node B (Node B), an evolved node B (eNode B), a base transceiver station (BTS), a mobile multihop relay (MMR)-BS, an advanced BS (ABS), and so on. Further, the base station may include all or a part of functions of the access point, the radio access station, the node B, the eNode B, the base transceiver station, the MMR-BS, and so on.

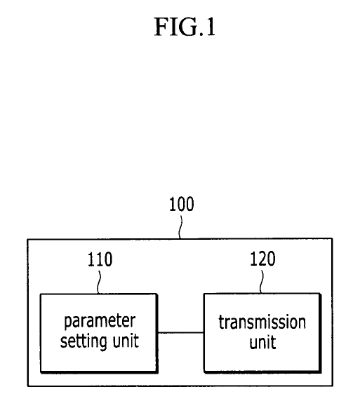

FIG. 1 is a schematic block diagram of a sleep mode controlling apparatus according to one exemplary embodiment of the present invention.

Referring to FIG. 1, the sleep mode controlling apparatus 100 includes a parameter setting unit 110 and a transmission unit 120.

The parameter setting unit 110 negotiates with a terminal about a sleep mode parameter of multi-carriers, the sleep mode parameter including information on a sleep window and a listening window. The information on the sleep window and the listening window may include, for example, information on a carrier to be used for data transmission in a sleep mode. The transmission unit 120 transmits data and/or a control message to the terminal based on the sleep mode parameter negotiated with the terminal. Data transmitted in the sleep mode includes periodic data, such as real-time traffic data and unsolicited grant service (UGS) traffic data, and aperiodic data, such as best effort (BE) traffic data and non-real time traffic data. The transmission unit 120 transmits a traffic advertisement message as a control message to the terminal in order to transmit aperiodic data during the listening window, and the terminal, having received the traffic advertisement message, receives the aperiodic data from a base station. On the contrary, if the transmission unit 120 transmits periodic data, the terminal can receive the periodic data during the listening window irrespective of presence or absence of the traffic advertisement message.

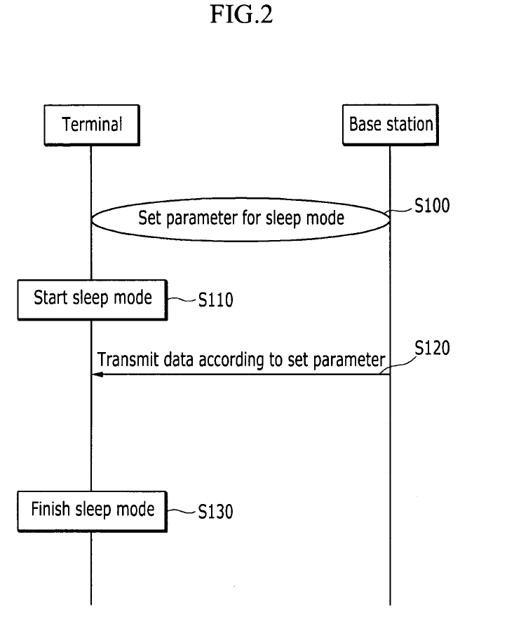

FIG. 2 is a flowchart showing a method for transmitting data from a base station to a terminal according to one exemplary embodiment of the present invention.

Referring to FIG. 2, the base station negotiates with the terminal to set a sleep mode parameter (S100). The process of setting the sleep mode parameter can be carried out by one of a MAC header, a MAC control message, and a control channel. The sleep mode parameter contains information on a sleep window and a listening window. The information on the sleep window and the listening window may include, for example, information on a carrier to be used to transmit data from the base station to the terminal operating in a sleep mode. In one example, if a primary carrier C0 and three secondary carriers C1, C2, and C3 are allocated to the terminal, the base station can set the primary carrier C0 as a carrier used to transmit data to the terminal operating in the sleep mode by negotiating with the terminal. In another example, all or a part of the primary carrier C0 and the three secondary carriers can be set as the carrier used to transmit data to the terminal operating in the sleep mode. The sleep mode parameter may further contain information on a sleep period of the terminal, a length of the listening window, and a length of the sleep window. A method of negotiation between the base station and the terminal may be in accordance with a general control message transmission/reception method. For instance, the negotiation can be performed through a control channel or medium access control (MAC) header. In order to ensure a reliability of a control message transmission and reception, an acknowledgement/no-acknowledgement (ACK/NACK) method may be used.

The terminal starts the sleep mode (S110), and the base station transmits data to the terminal according to the set parameter (S120). The data may be periodic data or aperiodic data.

The terminal receives the data from the base station based on the set parameter, and finishes the sleep mode when a predetermined event occurs (S130).

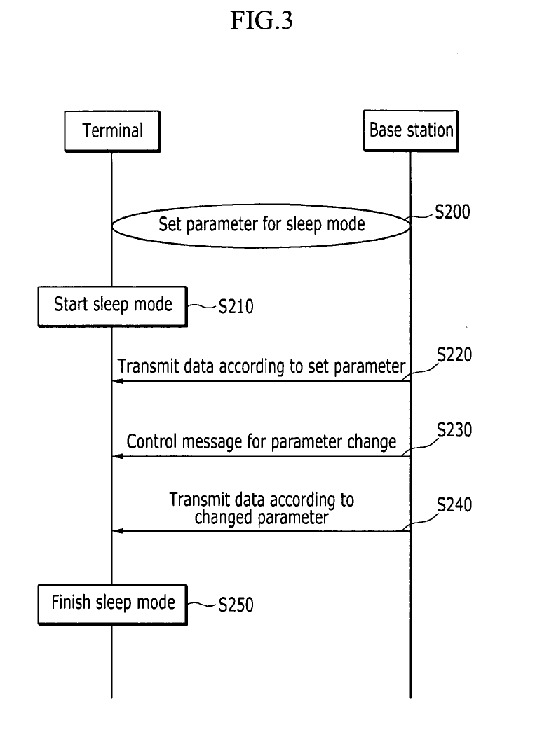

FIG. 3 is a flowchart showing a method for transmitting data from a base station to a terminal according to another exemplary embodiment of the present invention.

Referring to FIG. 3, the base station negotiates with the terminal to set a sleep mode parameter (S200). When the terminal starts a sleep mode (S210), the base station transmits data to the terminal according to the set parameter (S220). The process of setting the sleep mode parameter can be carried out by one of a MAC header, a MAC control message, and a control channel. In steps S200 to S220, description of the same parts as in FIG. 2 will be omitted.

There are some occasions when the sleep mode parameter needs to be changed while the terminal is operating in the sleep mode. These occasions occur when a carrier for transmitting data needs to be changed to save power or a primary carrier needs to be changed for load balance. In addition, there is an occasion when it is required to change a length of a listening window within a sleep period depending on the amount of data. In this case, the base station transmits, to the terminal, control information for changing the sleep mode parameter (S230). The control information for changing the parameter can be transmitted through the primary carrier in at least one of the MAC header, the MAC control message, and the control channel.

The base station transmits data to the terminal according to the changed parameter (S240), and finishes the sleep mode when a predetermined event occurs (S250).

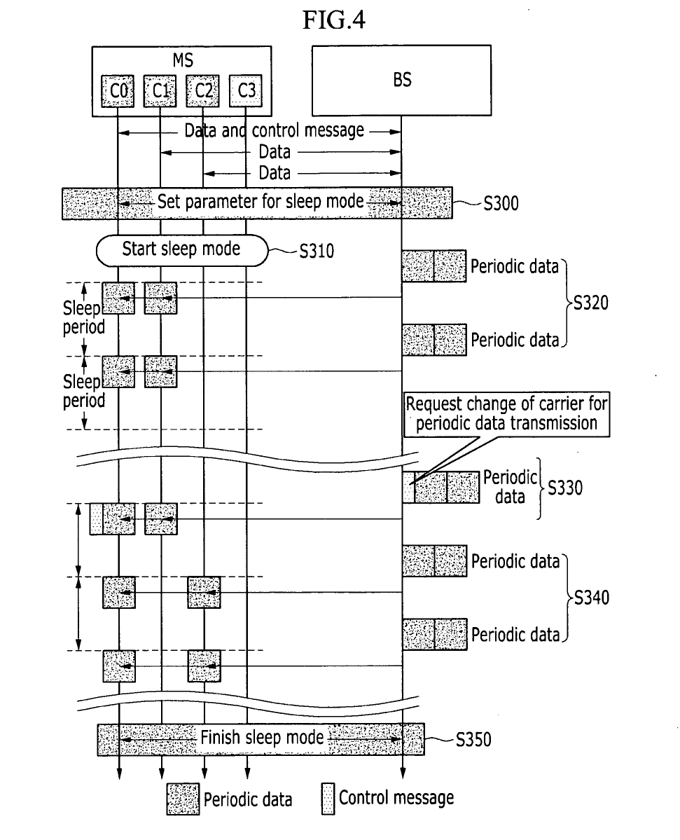

FIG. 4 is a flowchart showing a method in which a base station provides a periodic data transmission service to the terminal while the terminal is operating in a sleep mode in a wireless access system supporting multi-carriers according to one exemplary embodiment of the present invention. It is assumed that a carrier C0 is a primary carrier for transmitting data and a control message between the base station and the terminal and carriers C1 and C2 are secondary carriers for transmitting downlink data.

Referring to FIG. 4, the base station and the terminal set a carrier for transmitting periodic data from the base station to the terminal operating in the sleep mode (S300). In one example, the base station may be configured to transmit periodic data through the primary carrier C0. In another example, the base station may be configured to transmit periodic data through the primary carrier C0 and a part of the secondary carriers, e.g., the carrier C1. Hereinafter, it is assumed that the base station is configured to transmit periodic data through the primary carrier C0 and the secondary carrier C1.

The terminal starts the sleep mode (S310), the base station transmits periodic data to the terminal by the primary carrier C0 and the secondary carrier C1 during each listening window, and the terminal receives the periodic data transmitted from the base station through the primary carrier C0 and the secondary carrier C1 during each listening window (S320).

There is an occasion when the secondary carrier for transmitting periodic data needs to be changed according to a communication environment. When the secondary carrier needs to be changed, the base station transmits, to the terminal, control information to request the change (S330). The control information can be transmitted through the primary carrier C0 in the form of at least one of the MAC header, the MAC control message, and the control channel. Hereinafter, it is assumed that the base station has made a change request to transmit periodic data, not through the secondary carrier C1, but through the primary carrier C0 and the secondary carrier C2.

Afterwards, the base station transmits periodic data to the terminal through the primary carrier C0 and the secondary carrier C2 during each listening window, and the terminal receives the periodic data transmitted from the base station through the primary carrier C0 and the secondary carrier C2 during each listening window (S340).

The terminal finishes the sleep mode when a predetermined event occurs, and operates in a normal mode (S350). Examples of the predetermined event may include a generation of uplink data to be transmitted from the terminal and an expiry of a preset time.

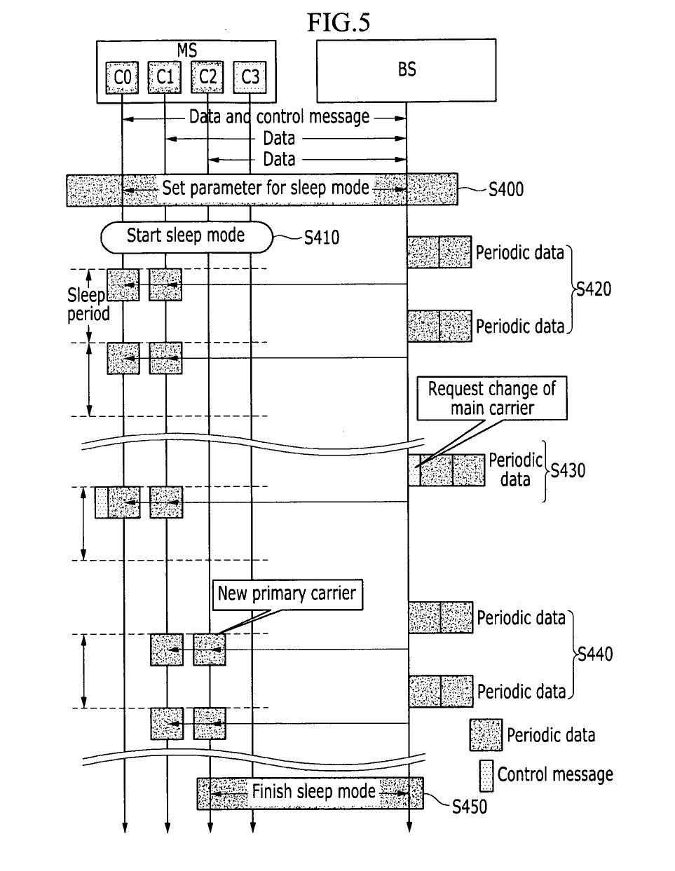

FIG. 5 is a flowchart showing a method in which a base station provides a periodic data transmission service to a terminal while the terminal is operating in a sleep mode in a wireless access system supporting multi-carriers according to another exemplary embodiment of the present invention. It is assumed that a carrier C0 is a primary carrier for transmitting data and a control message between the base station and the terminal, and carriers C1 and C2 are secondary carriers for transmitting downlink data.

Referring to FIG. 5, the base station and the terminal set a carrier for transmitting periodic data from the base station to the terminal operating in the sleep mode (S400). The base station may be configured to transmit periodic data through the primary carrier C0 and a part of the secondary carriers, e.g., the carrier C1. Hereinafter, it is assumed that the base station is configured to transmit periodic data through the primary carrier C0 and the secondary carrier C1.

The terminal starts the sleep mode (S410), the base station transmits periodic data to the terminal by the primary carrier C0 and the secondary carrier C1 during each listening window, and the terminal receives the periodic data transmitted from the base station through the primary carrier C0 and the secondary carrier C1 during each listening window (S420).

There is an occasion when the primary carrier needs to be changed for reasons of load balance, etc., while the terminal is operating in the sleep mode. When the primary carrier needs to be changed, the base station transmits, to the terminal, control information to request a change of the primary carrier (S430). The control information to request a change can be transmitted through the primary carrier C0 in the form of at least one of the MAC header, the MAC control message, and the control channel. Hereinafter, it is assumed that the base station has requested to change the primary carrier from the carrier C0 to the carrier C2.

Afterwards, the base station transmits periodic data to the terminal through the new primary carrier C2 and the secondary carrier C1 during each listening window, and the terminal receives the periodic data transmitted from the base station through the primary carrier C2 and the secondary carrier C1 during each listening window (S440). Then, the base station transmits a control message to the terminal through the new primary carrier C2.

The terminal finishes the sleep mode when a predetermined event occurs, and operates in the normal mode (S450). Examples of the predetermined event may include a generation of uplink data to be transmitted from the terminal and an expiry of a preset time.

Although FIG. 5 illustrates that, after changing the primary carrier, periodic data is transmitted through the new primary carrier and the secondary carrier, the base station may reset the carrier for transmitting periodic data to the terminal. At this point, the base station and the terminal can transmit and receive a control message to reset the carrier for transmitting periodic data through the new primary carrier C2.

On the other hand, the terminal in the sleep mode may transmit a control message requesting a change of the carrier to the base station through the primary carrier. Accordingly, the base station can transmit, to the terminal, the control message to change the carrier through the primary carrier, and transmit data to the terminal based on the changed carrier.

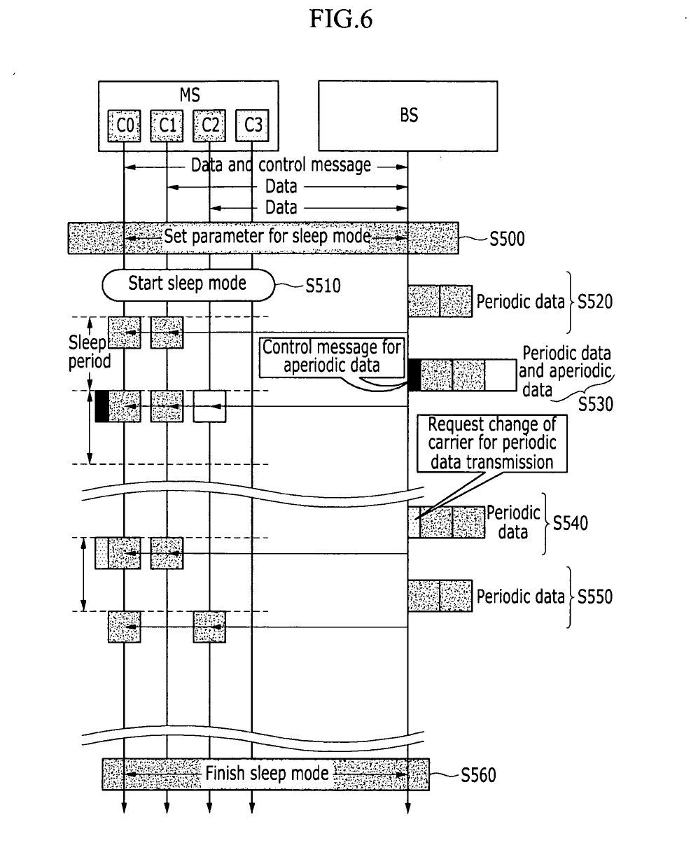

FIG. 6 is a flowchart showing a method in which a base station provides a periodic data transmission service and an aperiodic data transmission service to a terminal while the terminal is operating in a sleep mode in a wireless access system supporting multi-carriers according to one exemplary embodiment of the present invention. It is assumed that a carrier C0 is a primary carrier for transmitting data and a control message between the base station and the terminal, and carriers C1 and C2 are secondary carriers for transmitting downlink data.

Referring to FIG. 6, the base station and the terminal set a carrier for transmitting periodic data from the base station to the terminal operating in the sleep mode (S500). In one example, the base station may be configured to transmit periodic data through the primary carrier C0 and a part of the secondary carriers, e.g., the carrier C1. Hereinafter, it is assumed that the base station is configured to transmit periodic data through the primary carrier C0 and the secondary carrier C1.

The terminal starts the sleep mode (S510), the base station transmits periodic data to the terminal by the primary carrier C0 and the secondary carrier C1 during each listening window, and the terminal receives the periodic data transmitted from the base station through the primary carrier C0 and the secondary carrier C1 during each listening window (S520).

There is an occasion when the base station has to transmit aperiodic data to the terminal operating in the sleep mode. At this point, the base station transmits a control message for aperiodic data transmission through the primary carrier C0 and transmits aperiodic data, and the terminal monitors the control message of the primary carrier C0 and determines which carrier the aperiodic data is transmitted through (S530). As shown in the drawing, the aperiodic data can be transmitted along with the periodic data during the listening window.

As illustrated in FIGS. 4 and 5, the base station is able to change the primary carrier and/or the secondary carrier for transmitting periodic data while the terminal is operating in the sleep mode even though the base station provides the periodic and aperiodic data transmission services. For example, in the case that the carrier for transmitting aperiodic data is changed to the primary carrier C0 or the secondary carrier C2, the base station transmits a control message to request a change through the primary carrier C0 (S540) and transmits periodic data through the primary carrier C0 and the secondary carrier C2, and the terminal receives the periodic data through the primary carrier C0 and the secondary carrier C2 (S550). Although not shown, in the case that the primary carrier is changed, the terminal can monitor the control message for aperiodic data using the new primary carrier and receive the aperiodic data.

The terminal finishes the sleep mode when a predetermined event occurs, and operates in a normal mode (S560).

FIGS. 4 to 6 illustrate that the base station changes the primary carrier and/or the carrier for transmitting periodic data during the sleep mode operation. The base station can change other parameters. For example, a required length of a listening window may vary in accordance with data to be transmitted. That is, the greater the amount of data, the longer the listening window has to be, and the less the amount of data, the shorter the listening window has to be. If the listening window is maintained at a constant length even when the amount of data is small, this causes the terminal to waste power. The following description will be given of a case where the base station changes the length of the listening window during the sleep mode operation.

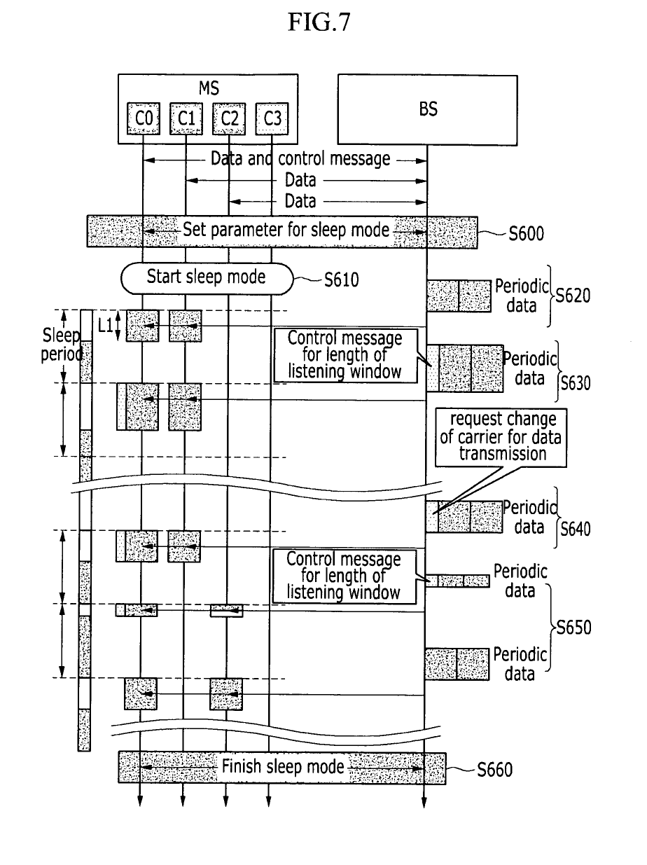

FIG. 7 is a flowchart showing a method in which a base station provides a data transmission service to a terminal while the terminal is operating in a sleep mode in a wireless access system supporting multi-carriers according to one exemplary embodiment of the present invention. It is assumed that a carrier C0 is a primary carrier for transmitting data and a control message between the base station and the terminal, and carriers C1 and C2 are secondary carriers for transmitting downlink data. This applies not only to periodic data transmission but also to aperiodic data transmission.

Referring to FIG. 7, the base station and the terminal sets a sleep mode parameter containing information on a sleep window and a listening window (S600). The process of setting the sleep mode parameter can be carried out by one of a MAC header, a MAC control message, and a control channel. The sleep mode parameter contains information on a carrier for data transmission, information on a length of the listening window within a given sleep period, and so on. Hereinafter, it is assumed that the base station transmits data through the primary carrier C0 and the secondary carrier C1, and the length of the listening window within one sleep period is L1.

The terminal starts the sleep mode (S610), the base station transmits periodic data to the terminal by the primary carrier C0 and the secondary carrier C1 during each listening window, and the terminal receives the periodic data transmitted from the base station through the primary carrier C0 and the secondary carrier C1 during each listening window (S620).

If the base station wants to temporarily change the length of the listening window, the base station transmits control information instructing to change the length of the listening window for the multi-carriers through the primary carrier C0 (S630), and transmits data during the listening window of which the length is changed (S640). The control information can be transmitted through at least one of the MAC header, the MAC control message, and the control channel.

Here, the base station may change the primary carrier and/or the carrier for data transmission while the terminal is operating in the sleep mode. Taking as an example the case where the carrier for data transmission is changed to the primary carrier C0 and the secondary carrier C2, the base station transmits a control message to request a change of the carrier through the primary carrier C0 and transmits data through the primary carrier C0 and the secondary carrier C2, and the terminal receives the data through the primary carrier C0 and the secondary carrier C2 (S650).

The terminal finishes the sleep mode when a predetermined event occurs, and operates in a normal mode (S660).

Although FIG. 7 illustrates that the length of the listening window is temporarily changed only when there is a request to change the length of the listening window and the listening window has a pre-negotiated length during the remaining portion of the sleep period, the listening window also may have a changed length during the entire sleep period after the change request is made. Moreover, the listening window may have a changed length during the entire sleep period within a predetermined period of time after the change request is made.

In this manner, power consumption of the terminal can be saved by variably setting the length of the listening window.

As above, although the description has been made of the exemplary embodiment in which a base station transmits downlink data to a terminal, the technical concept of the present invention is not limited thereto. If there is uplink data to be transmitted to the base station while the terminal is operating in a sleep mode, the uplink data can be transmitted based on a parameter negotiated with the base station before the sleep mode is started, or the uplink data can be transmitted based on a control message received from the base station through a primary carrier during a listening window.

The exemplary embodiments of the present invention described above are not only implemented by the method and apparatus, but they may be implemented by a program for executing the functions corresponding to the configuration of the exemplary embodiment of the present invention or a recording medium having the program recorded thereon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a base station transmits downlink data in a wireless access system supporting multi-carriers, the method comprising:
negotiating with a terminal about a sleep mode parameter including information on a sleep window and a listening window;
if the terminal is operating in a sleep mode, transmitting information on a carrier used for data transmission among the multi-carriers to the terminal through at least one of a medium access control (MAC) header, a MAC control message, and a control channel; and
transmitting data to the terminal based on the information during the listening window.

2. The method of claim 1, wherein the carrier used for data transmission comprises at least one secondary carrier.

3. The method of claim 1, further comprising transmitting the MAC header indicating that there is no data transmission using a secondary carrier through a primary carrier.

4. The method of claim 1, further comprising transmitting the MAC header instructing to change a length of the listening window for the multi-carriers through a primary carrier.

5. The method of claim 1, further comprising:
if the terminal is operating in the sleep mode, changing the parameter;
transmitting information about the changed parameter to the terminal; and
transmitting data to the terminal during the listening window based on the changed parameter.

6. The method of claim 5, wherein the information about the changed parameter comprises information indicating that the primary carrier is changed to other carriers among the multi-carriers.

7. The method of claim 5, wherein the information about the changed parameter comprises information indicating that the carrier used to transmit the data is changed to other carriers among the multi-carriers.

8. The method of claim 5, wherein the information about the changed parameter is information changed about a length of the listening window.

9. The method of claim 1, wherein the data comprises periodic data.

10. The method of claim 1, further comprising:
transmitting control information for an aperiodic data transmission to the terminal through a primary carrier; and
transmitting the aperiodic data to the terminal based on the control information.

11. A method in which a terminal operates in a sleep mode in a wireless access system supporting multi-carriers, the method comprising:
negotiating with a base station about a sleep mode parameter including information on a sleep window and a listening window;
if the terminal is operating in the sleep mode, receiving information on a carrier used for data transmission among the multi-carriers from the base station through at least one of a medium access control (MAC) header, a MAC control message, and a control channel; and
receiving data from the base station based on the information during the listening window.

12. The method of claim 11, wherein the data comprises periodic data.

13. The method of claim 11, wherein the carrier used for data transmission comprises at least one secondary carrier.

14. The method of claim 13, further comprising transmitting the MAC header indicating that there is no data transmission using a secondary carrier through a primary carrier.

15. The method of claim 11, further comprising:
transmitting control information requesting a change of the carrier to the base station through a primary carrier; and
receiving downlink data from the base station or transmitting uplink data to the base station based via the changed carrier.

16. A sleep mode controlling apparatus of a base station of a wireless access system supporting multi-carriers, the apparatus comprising:
a parameter setting unit for negotiating with a terminal about a sleep mode parameter including information on a sleep window and a listening window; and
a transmission unit for, if the terminal is operating in a sleep mode, transmitting information on a carrier used for data transmission among the multi-carriers to the terminal through at least one of a medium access control (MAC) header and a MAC control message, and transmitting data to the terminal based on the information during the listening window.

17. The apparatus of claim 16, wherein the transmission unit transmits the data by using a primary carrier and at least one secondary carrier.

18. The apparatus of claim 17, wherein the transmission unit transmits the MAC header indicating that there is no data transmission using a secondary carrier through a primary carrier.

19. The apparatus of claim 16, wherein the transmission unit transmits the MAC header instructing to change a length of the listening window for the multi-carriers through a primary carrier.

20. The apparatus of claim 16, wherein the data comprises periodic data.
